(19) United States
(12) Patent Application Publication
(10) Pub. No.: US 2011/0271544 A1
(43) Pub. Date: Nov. 10, 2011

(54) Bottle dryer using passive air collection

(76) Inventor: Blaine C. Readler, San Diego, CA (US)

(21) Appl. No.: 12/800,116

(22) Filed: May 10, 2010

(51) Int. Cl. F26B 25/00

(52) U.S. Cl. 34/104

(57) ABSTRACT

A method for drying the interior of bottles that uses an air-gathering scoop insert constructed so as to catch and direct naturally occurring air currents into the interior, thus supplying dry air, and expelling evaporated water vapor. To this end, the shape of the insert exhibits a center of gravity located to tilt the scoop forward to better aid the capture of air currents. A narrow tail resides inside the bottle, serving to hold upright a scoop lying above the bottle's neck to capture and direct natural air currents down and into the interior. Additionally, the tail of the scoop inside the bottle can optionally be curved forward, again aiding in tilting the scoop forward and advantageously directing air flows. Further, optional cutaways can be removed from the tail of the scoop which allow in-flowing air to reach the entire inside perimeter of the bottle.

### CROSS-REFERENCE TO RELATED APPLICATIONS

Not Applicable.

### SEQUENCE LISTING

Not Applicable

### BACKGROUND OF THE INVENTION

1. Field of the Invention

This invention relates to drying devices, and specifically to drying devices that enhance circulation and flow in bottles that are wet from washing or consumption of water.

2. Description of Prior Art

The importance of conservation is ever more apparent as the deleterious consequences on the Earth's environment from manufacturing and consumption becomes increasingly evident. Consumption of a product requires the manufacture of its replacement, which in turn requires energy and the concomitant burning of fossil fuels and consequential carbon-dioxide release into the atmosphere, which in turn contributes in incremental fashion to global warming. Besides the undesirable effect of depletion of limited natural fuels, the manufacturing processes also results in waste materials, which, along with the original discarded product, are returned to the environment as unwelcome waste. Clearly, reuse of manufactured consumer products is beneficial to our threatened environment.

One very visible source of discarded consumer product is bottled water. According to the Container Recycling Institute, 15 million barrels of oil are used in the USA each year to make plastic water bottles, 86% of which are deposited in landfills or incinerated, at a rate of 30 million per day. The World Wildlife Foundation estimates that around 1.5 million tons of plastic is used globally each year in water bottles. Worldwide, vast amounts of energy are used to transport bottled water. Fiji water, for example, is transported six thousand miles for consumption in the USA. Conscientious people seek alternatives, and many recognize that simple tap water is often actually safer than many sources of commercial bottled water. Alternatively, they purchase bottled water in large, reusable containers that are refilled either by the consumer at filtered water dispensers for a small fee, or delivered directly to the home by a bottled water provider. In either case, though, the consumer is left with the need to transport personal quantities of the water from either the tap or the large dispensing container along with them on their exercise programs or daily routines away from the house. One solution would be to buy large stocks of empty plastic bottles that are discarded after each use, but this, of course, completely contradicts the goal of conservation.

The obvious solution is to utilize personal bottles that are then reused. These may be rugged and feature-rich containers that are purchased for a sizable sum with the expectation that the value will be regained multiple-fold with repeated use. Alternatively, the solution might be as simple as a plastic soft drink bottle with a screw-on cap. In all cases, though, the user will want to occasionally wash the reused bottle, which in turn will then need to be dried. Even if not washed, a bottle left wet inside after use will develop bacterial and fungal growth in a day or two, presenting offensive or even harmful consequences.

Additionally, babies and young children make use of bottles for drinking milk and various flavored drinks, which then require washing.

Thus there is a strong need to dry reusable bottles.

A commonly available method involves suspending the bottles upside-down on pegs or rods. Although this facilitates draining excess water from the bottle, it does little, or worse, to aid in the complete drying. This is mostly because the narrow neck of the majority of bottles restricts natural airflow into the interior space, which then remains saturated with water vapor, preventing further evaporation. Further, it is known in physics that humid air is lighter than dry air, and thus the vapor-saturated air in the bottle remains inside, buoyed by the relatively dry ambient air outside.

A number of prior inventions attempted to deal with the problem of drying wet bottles, but, although able to do so quickly, all require the use of applied energy and are complicated with moving parts.

U.S. Pat. No. 4,297,792 describes a drying method suitable for industrial applications that uses heated brushes for drying the outside of the jar in preparation for applying labels. Although one could conceive how a similar brush method might be applied to the inside of the container, this approach is suitable principally for industrial applications, and even if scaled down to home use, remains still far too complicated, and thus expensive, for the average kitchen.

U.S. Pat. No. 4,812,621, while described as a means for drying dishes, could be envisioned to be used for bottles as well. However, the method uses a heating element and electromechanical fan to force heated air for drying, both components requiring energy and embodying the aforementioned complexity.

U.S. Pat. No. 5,469,635 is also appropriate for home use, and while foregoing a heating element, still forces air to bottle interiors via tubes upon which the upturned bottles are suspended via an electromechanical fan, again requiring energy and embodying complexity.

Similarly, U.S. Pat. No. 6,688,019 also uses a fan to force air through hollow posts upon which upturned bottles are suspended, yet again including unwelcome expense and complexity.

What would be useful would be an effective means to dry the interior of bottles without applied electrical energy.

A method of drying fogged surfaces without direct mechanized help is described in U.S. Pat. No. 5,652,965. Here, lateral air scoops direct air rushing past the head of a skier into the interior of the goggles to aid in keeping the interior surface from gathering condensed water. This method, however, relies substantially on the forward motion of the skier to force air into vents in the goggles, so, in a sense the drying method is not entirely passive, but relies on the induced motion of the wearer.

A second method of forcing air across a wet surface without apparent direct mechanized aid is described in U.S. Pat. No. 4,979,809. Here again, an air scoop directs air rushing past the side mirror of a car onto the mirror surface, thus aiding in blowing away errant water droplets. However, although not obviously mechanized, the method relies completely on the motion of the vehicle, and thus is, in fact, in a real sense mechanized.

Both of the preceding inventions rely substantially on induced motion and are therefore effectively useless as applied to drying bottles in a home.

A simple and effective means to dry the interior of bottles without applied electrical energy remains unfulfilled, and would be very useful.

### SUMMARY OF THE INVENTION

Therefore, in accordance with the Present invention, a method for drying the interior of bottles uses an air-gathering scoop insert to intercept and direct natural air flows into the interior, thus supplying dry air, and expelling evaporated water vapor. The insert is constructed such that naturally occurring air currents are effectively directed inwards. To this end, the shape of the insert exhibits a center of gravity located to tilt the scoop forward to better aid the capture of air currents. A narrow tail resides inside the bottle serving to hold upright a scoop lying above the bottle's neck to capture and direct natural air currents down and into the interior.

Additionally, the tail of the scoop inside the bottle can be bent forward in a concave fashion, again aiding in tilting the scoop forward and advantageously directing air flows.

A further optional feature is cutaways in the tail of the scoop that allow inflowing air to reach the entire inner perimeter of the bottle.

Objects and Advantages

Accordingly, several objects and advantages of the present invention are:

a) to provide a means to dry the interior of liquid bottles that does not require applied energy;

b) to provide such a bottle dryer that is extremely easy to use;

c) to provide such a bottle dryer that is small and easily stored in a kitchen drawer;

d) to provide such a bottle dryer that is durable and reliable;

e) to provide such a bottle dryer that is inexpensive.

### BRIEF DESCRIPTION OF THE DRAWINGS

FIG. 1a is an illustration of the preferred embodiment device showing a frontal view;

FIG. 1b is an illustration of the same showing a side view;

FIG. 2 illustrates the preferred embodiment device when inserted into its operative position inside a bottle ;

FIG. 3 shows the preferred embodiment tilted forward to optimally catch air flow;

FIG. 4 shows the preferred embodiment device with the insert tail curved forward;

FIG. 5 shows the preferred embodiment device with cutaways removed from the insert tail;

FIG. 6a illustrates the effect of two different locations of center of gravity with the preferred embodiment tilted forward;

FIG. 6b illustrates the effect of the same two locations of center of gravity, but now with the preferred embodiment tilted backwards.

### DETAILED DESCRIPTION OF THE INVENTION

Although not obvious to the casual perceptions of most people, an average home is infused with natural air flows. These result from emissions of forced-air heating/air-conditioning vents, convection due to temperature differences as occur with baseboard heating, radiant heating, and the natural thermal loading of sunshine through windows and outer walls, and even the motions of people. To a water bottle sitting either upright or suspended upside-down, these natural air currents do very little to aid interior drying since the air currents pass around and over the bottle, and not inside. Also, many bottles used for drinking have relatively narrow necks which further greatly restrict entry of air currents.

The inventive device serves to direct these naturally occurring air flows into the interior of a bottle where they displace the high vapor content air in the proximity of the remaining water droplets with dryer air to greatly accelerate continued evaporation.

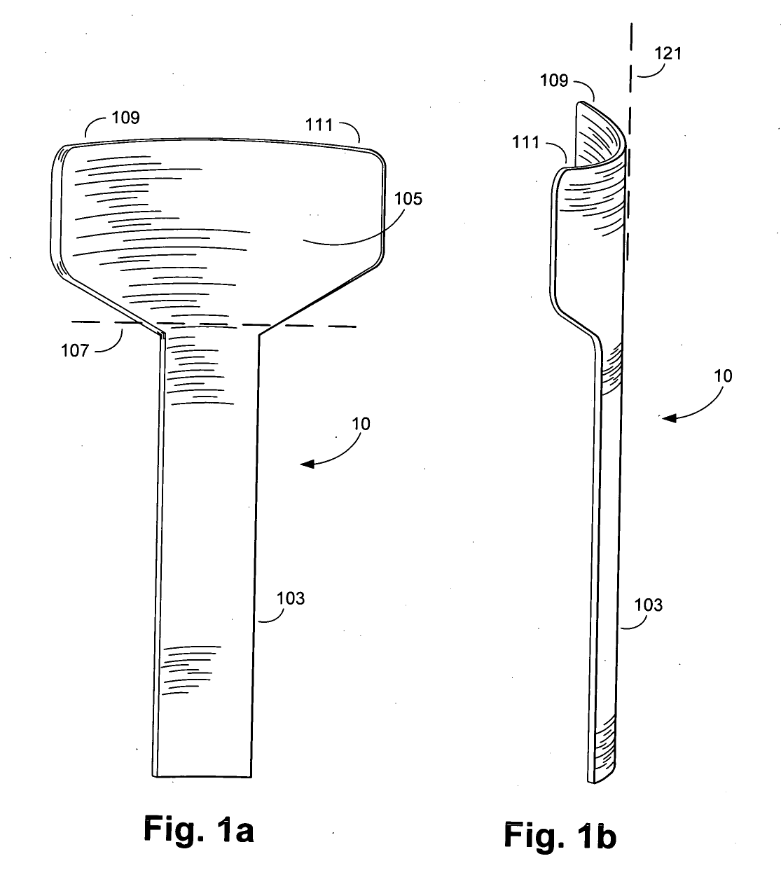

Air Scoop, FIGS. 1a, 1b

FIG. 1a shows the preferred embodiment 10 of the basic bottle dryer as seen head-on, while FIG. 1b shows the same as would be seen from the side. Downward extending tail 103 serves to provide counterweight to keep air scoop 105 upright when the bottle dryer is inserted into the bottle and is balanced where the bottle dryer makes contact with the rim of the bottle's mouth in, e.g., plane 107. Side tabs 109 and 111 are bent forward to better intercept, contain, and direct natural air flows, and also, as will be explained later, to optimally angle the bottle dryer.

This forward-bending form is better seen from the side view shown in FIG. 1b, where for ease of construction and unimpeded air flow, the entire width of the bottle dryer is bent in a concave fashion away from longitudinal axis 121. Here it can be seen that side tabs 109 and 111 are bent in a smooth curve away from longitudinal axis 121. In the preferred embodiment, tail 103 is also curved, but this is mainly for ease of manufacture, although also providing mechanical stability to the overall structure.

Since the only material requirements of the device are sufficient rigidity when formed into a relatively thin and curved layer, a wide variety of materials could be employed, such as, for example, plastic, aluminum, wood, or even cardboard.

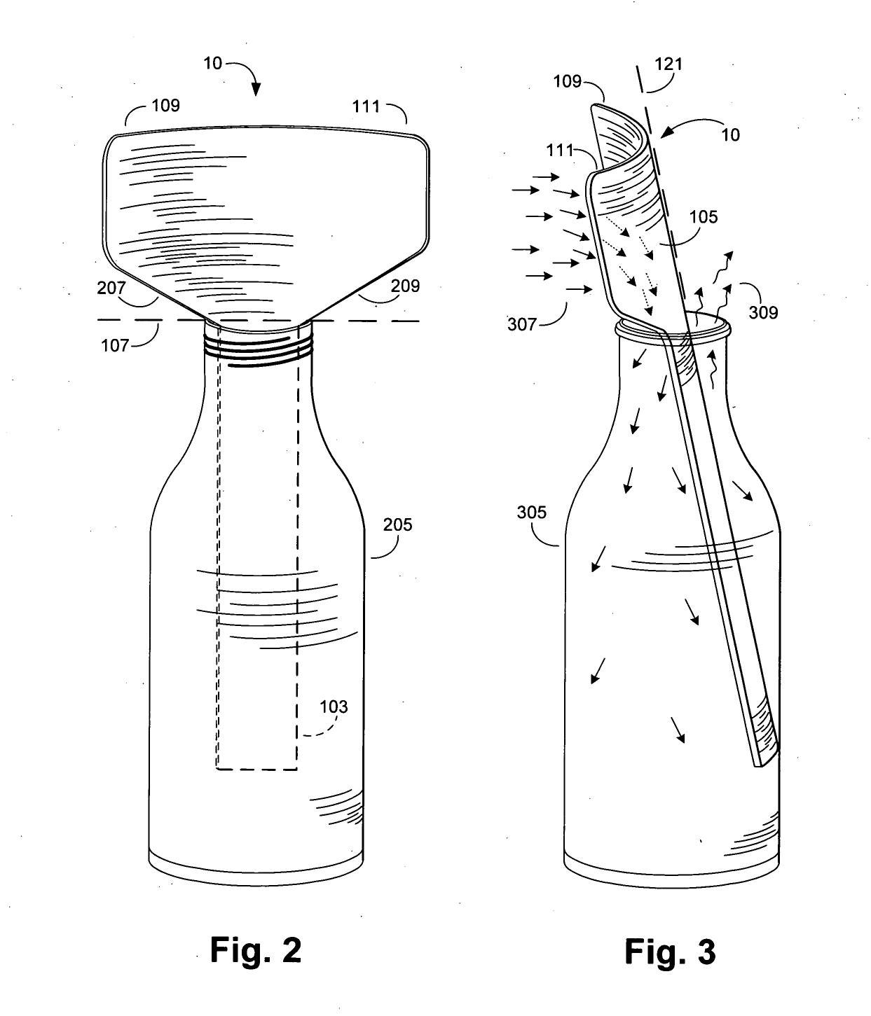

Air Scoop Operatively Placed in Bottle, FIG. 2

In FIG. 2, the preferred embodiment basic bottle dryer 10 is shown operatively positioned in example bottle 205, with tail 103 residing inside the bottle as would be the case in an application to dry the bottle. As indicated earlier, bottle dryer 10 rests against the mouth rim of bottle 205 along plane 107, around which, the bottle dryer can swing, tilting either forward or backwards. Since side tabs 109 and 111 have angled bottoms 207 and 209, a single size of bottle dryer can be used with bottles exhibiting a range of mouth opening widths, where the example bottle shown in FIG. 2 would exhibit the approximately smallest width neck for this particular size of bottle dryer.

Air Scoop Tilted, FIG. 3

FIG. 3 shows the bottle dryer 10 as would be seen from the side, now placed in a different example bottle 305 that is e.g. transparent, so that the entire length of the bottle dryer is now visible for clarity of illustration. Key here is the forward tilted position of the bottle dryer, angling air scoop 105 forward so as the direct natural air flows, represented by small arrows 307, downward into the bottle, in turn expelling vapor-laden air 309. In this basic preferred embodiment, this forward tilting is achieved by ensuring that side tabs 109 and 111 are bent far enough forward from longitudinal axis 121 so as to position the virtual center of gravity of the bottle dryer in three spatial dimensions also forward of longitudinal axis 121. Additionally, the total integrated portion of mass of the bottle dryer located above the rim of the bottle is greater than the total integrated portion of mass of the bottle dryer located below the rim. In this way, the virtual center of gravity of the bottle dryer is located in space so as to cause air scoop 105 to tilt forward a maximum amount.

Bottles exhibiting wider mouth rims than the example shown in FIG. 3 will cause the bottle dryer's tilting fulcrum to move upwards, thus effectively moving the bottle dryer's center of gravity lower relative to the tilting fulcrum. As such, for a given form of bottle dryer, a maximum width of bottle rim mouth may be encountered above which the bottle dryer may not spontaneously tilt forward into the optimal position to direct air flows downward. Because of this, it might be advantageous to offer a multiple of sizes of bottle dryer devices, where each size is appropriate for a certain range of bottles and associated bottle rim widths. Supportively, larger bottles would benefit from larger air scoops in any case.

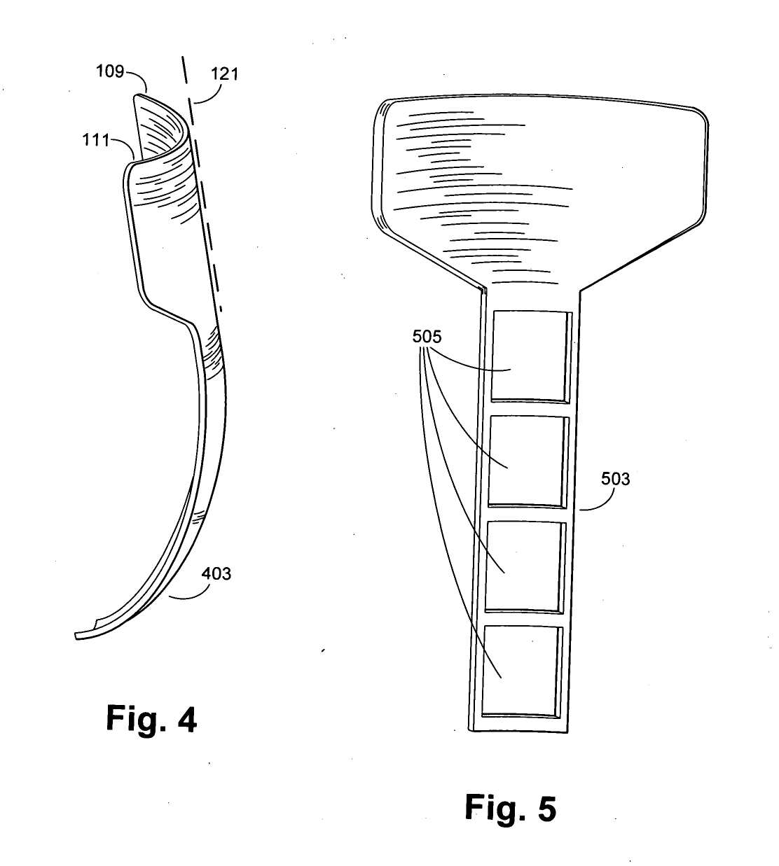

Tail Curved Forward, FIG. 4

FIG. 4 shows an optional form of the preferred embodiment basic bottle dryer, where the tail 403 is now curved forward. This further serves to locate the bottle dryer's center of gravity farther forward from longitudinal axis 121 in three dimensional space. Although potentially adding slightly to the difficulty of manufacture, a forward-curving tail advantageously allows potentially less material and degree of curvature of side tabs 109 and 111, while achieving a similar desirable tendency for forward tilting.

Tail With Cutaways, FIG. 5

FIG. 5 shows yet another optional form of the preferred embodiment basic bottle dryer, now with sections 505 of the tail 503 removed. The primary advantage of the removed material is to allow downward directed air to pass through the openings to reach the portions of the inner surface of a bottle directly behind the bottle dryer tail. This in turn facilitates even drying throughout the inside of the bottle, minimizing the time required for complete drying.

Whereas the optional cutaway sections 505 shown in FIG. 5 provide for a better overall drying, it should be recognized that the eliminated material also reduces the mass of the bottle dryer's tail, thus moving the aforementioned center of gravity even higher above the contact points with the bottle's mouth rim. While this may seem at first consideration to be beneficial in promoting an advantageous forward tilt, it should be recognized that the mass of the tail also provides a stabilizing effect. Specifically, the tail serves to counter a backward tilting of the bottle dryer. This is illustrated in the next figures.

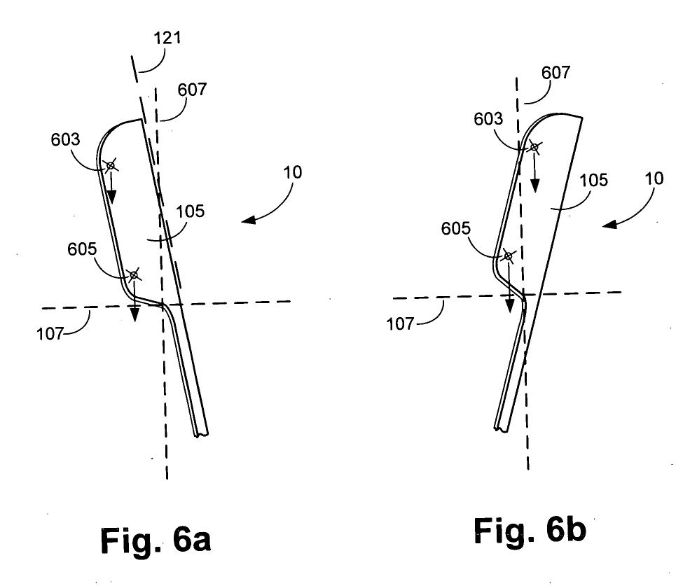

Center of Gravity vis-a-vis Backward Tilt, FIGS. 6a, 6b

FIG. 6a shows a side-view of just the upper portion of the basic preferred embodiment bottle dryer 10 tilted forward in its optimal position. Also shown for demonstration are two hypothetical centers of gravity 603 and 605, here indicated with a circle and cross-hairs, both the same perpendicular distance from longitudinal axis 121, but of different heights above the bottle mouth tilting plane 107, as might occur with different masses of tail as discussed in the previous paragraph. For the sake of clarity, these centers of gravity are placed in somewhat probable exaggerated distances apart from each other and from longitudinal axis 121, but the principles here explained would hold for more probable locations as well. In FIG. 6a with the bottle dryer tilted forward, both centers of gravity lie to the left of vertical axis 607, which is aligned with the pull of gravity, and which passes through the fulcrum point intersecting the plane 107 lying at the rim of the bottle's mouth, and around which the bottle dryer tilts. Since both centers of gravity lie to the left of vertical axis 607, in this position they both represent a stable configuration, since both tend to draw the air scoop 105 beneficially downward, in concert with the forward tilt position.

FIG. 6b now shows the same upper portion of bottle dryer 10 with the same hypothetical set of different centers of gravity 603 and 605. Here, though, the bottle dryer is now initially positioned in a backward tilting orientation. In this position can be seen radically different consequences of the different locations of the two centers of gravity. Whereas the lower center of gravity 605 is still positioned to the left of vertical axis 607 and the fulcrum point intersecting the plane 107, thus serving to tilt the bottle dryer's air scoop 105 once again to the preferred forward tilted position, the higher center of gravity 603 is now positioned to the right of the fulcrum point, and will cause the bottle dryer to remain in the undesirable backward tilted position.

Therefore, the dimensions and material distribution of the bottle dryer are important in order to ensure that the bottle dryer will automatically tilt forward should the user inadvertently insert the device in an undesirable backward-tilting position. Specifically, it is important that the design of the bottle dryer ensure that the resulting center of gravity be low enough and far enough forward to ensure a positive forward tilt tendency when the device is placed initially in a backward tilt position inside various target bottles. For example, ensuring that side tabs 109 and 111 from earlier FIG. 1b are bent sufficiently forward aids in placing the center of gravity also forward, while adding relatively dense counterweight material at the very bottom of a tail that has cutaways as shown in earlier in FIG. 5 aids in placing the center of gravity lower. In the latter prescription, additional precaution must be made against locating so much weight in the tail so as to cause the center of gravity to be positioned below the fulcrum point, for this could cause air scoop 105 to exhibit the unfortunate tendency to not tilt sufficiently forward, or more disastrously, to actually naturally tend to tilt backwards.

### CONCLUSION, RAMIFICATIONS, AND SCOPE

In operation, trial observations reveal that the basic preferred embodiment dries a bottle anywhere from three to ten times faster, depending on ambient humidity and the degree of air flow, than the same style bottle placed next to it without the advantage of the invention. Importantly, by drying the bottles in a period of hours instead of days, mold spores, e.g., mildew, which are present invisibly in the air virtually everywhere, are not provided sufficient time to germinate and grow.

In use, the invention is inserted into a wet bottle or other bottle that has been washed or otherwise recently emptied of liquid, and the bottle is then placed in a location likely to encounter breezes or stray wafts of air, such as a kitchen counter. Due the invention's durable one-piece construction and small size, it can handily be stored in a kitchen counter drawer, ready for retrieval and use at a moment's notice. Additionally, the relative uncomplicated manufacturing allows an inexpensive final product.

Accordingly, the reader will understand that due to the extreme simplicity of use, ease of storage and retrieval, and low cost, a homeowner will be more inclined to reuse and keep safely dry drinking bottles, thus benefiting both themselves and the Earth's ecology.

Although the preferred embodiment described herein exhibits a specific and particular shape, it will be understood that other shapes and designs effecting the same purpose of directing airflow downward into a bottle might work equally or adequately well. For example, the top of the air scoop might be curved forward in addition to, or instead of, the side tabs 109 and 111, or angled bottoms 207 and 209 might be curved instead of straight. Indeed, angled bottoms 207 and 209 might even be completely horizontal.

I claim:

1) a bottle dryer that uses naturally occurring air flows to evaporate residual liquid from inside a bottle without the aid of additional applied energy, wherein,
a) said bottle dryer operates with bottles exhibiting a range of mouth rim diameter sizes,
b) said bottle dryer includes an upper air scoop portion that has a width that is larger than the largest mouth rim diameter of said range of mouth rim diameter sizes,
c) said bottle dryer includes a lower tail portion that has a width that is smaller than the smallest bottle mouth rim diameter of said range of mouth rim diameter sizes,
d) at least one bottom edge of said air scoop rests on the mouth rim of the bottle to be dried so that the said tail portion hanging inside said bottle positions the air scoop above the bottle to advantageously intercept said naturally occurring air flows,
e) at least one edge of said air scoop is bent forward, operating to direct said naturally occurring air flows inward,
whereby, when inserted into a bottle, said bottle dryer intercepts natural currents of air and operates to direct them down and into said bottle, thus supplying relatively dry air, and expelling evaporated water vapor.

2) a bottle dryer according to claim 1, wherein the center of gravity of said bottle dryer occurs forward of the longitudinal axis of said bottle dryer so that said air scoop of said bottle dryer tends to tilt forward, further aiding in directing said natural air flows inward.

3) a bottle dryer according to claim 1, wherein said tail is curved forward so as to aid in tilting said air scoop of said bottle dryer forward, thus aiding in directing said natural air currents into said bottle.

4) a bottle dryer according to claim 1, wherein said tail includes portions removed, thus allowing inwardly directed air currents to reach substantially the majority of the interior surface of said bottle to be dried.
